(19) United States
(12) Patent Application Publication
(10) Pub. No.: US 2026/0044375 A1
(43) Pub. Date: Feb. 12, 2026

(54) ACCELERATING A PROCESS OF TRAINING MIXTURE-OF-EXPERTS MODELS

(71) Applicant: Lemon Inc., Grand Cayman (KY)

(72) Inventors: Ziheng JIANG, Los Angeles, CA (US); Yanghua PENG, Los Angeles, CA (US); Haibin LIN, Los Angeles, CA (US); Xin LIU, Los Angeles, CA (US)

(21) Appl. No.: 18/798,697

(22) Filed: Aug. 8, 2024

(51) Int. Cl. G06F 9/50; G06F 9/54

(52) U.S. Cl. CPC G06F 9/5027; G06F 9/5061; G06F 9/54

(57) ABSTRACT

The present disclosure describes techniques for accelerating a process of training mixture-of-experts (MOE) models. A sequence in training data is partitioned into a plurality of segments. The plurality of segments are input in parallel into a plurality of devices. Attention computations of a layer are implemented in parallel by the plurality of devices. Tokens from the attention computations of the layer are dispatched to different devices among the plurality of devices and implementing expert computations of the layer by the different devices. A communication volume is reduced by maintaining, after completing the expert computations of the layer, at least a portion of tokens from each of the different devices on the same device for implementing attention computations of a subsequent layer.

### BACKGROUND

Machine learning models are increasingly being used across a variety of industries to perform a variety of different tasks. Improved techniques for efficiently scaling machine learning models are desirable.

### BRIEF DESCRIPTION OF THE DRAWINGS

The following detailed description may be better understood when read in conjunction with the appended drawings. For the purposes of illustration, there are shown in the drawings example embodiments of various aspects of the disclosure; however, the invention is not limited to the specific methods and instrumentalities disclosed.

FIG. 1 shows an example system for accelerating a process of training mixture-of-experts (MoE) models in accordance with the present disclosure.

FIG. 2 shows an example system for sequence parallel attention in accordance with the present disclosure.

FIG. 3 shows an example attention block in accordance with the present disclosure.

FIG. 4 shows an example overlapping communication technique in accordance with the present disclosure.

FIG. 5 shows an example system for out-of-order parallelism in accordance with the present disclosure.

FIGS. 6A-B show an example load balancing with out-of-order parallelism in accordance with the present disclosure.

FIG. 7 shows an example process for accelerating a process of training MoE models in accordance with the present disclosure.

FIG. 8 shows an example process for accelerating a process of training MoE models in accordance with the present disclosure.

FIG. 9 shows an example process for accelerating a process of training MoE models in accordance with the present disclosure.

FIG. 10 shows an example process for accelerating a process of training MoE models in accordance with the present disclosure.

FIG. 11 shows an example process for accelerating a process of training MoE models in accordance with the present disclosure.

FIG. 12 shows an example process for accelerating a process of training MoE models in accordance with the present disclosure.

FIG. 13 shows an example table illustrating evaluation results in accordance with the present disclosure.

FIG. 14 shows an example table illustrating evaluation results in accordance with the present disclosure.

FIG. 15A shows an example table illustrating evaluation results in accordance with the present disclosure.

FIG. 15B shows an example table illustrating evaluation results in accordance with the present disclosure.

FIG. 16 shows an example graph illustrating evaluation results in accordance with the present disclosure.

FIG. 17A shows an example graph illustrating evaluation results in accordance with the present disclosure.

FIG. 17B shows an example graph illustrating evaluation results in accordance with the present disclosure.

FIG. 18 shows an example chart illustrating evaluation results in accordance with the present disclosure.

FIG. 19 shows an example computing device which may be used to perform any of the techniques disclosed herein.

### DETAILED DESCRIPTION OF ILLUSTRATIVE EMBODIMENTS

Described here are improved techniques for accelerating a process of training mixture-of-experts (MoE) models. In recent years, Large Language Models (LLMs) have emerged as a cornerstone of modern artificial intelligence research, showcasing unparalleled capabilities in generating human-like text, understanding complex queries, and facilitating groundbreaking advancements across numerous domains. The significance of LLMs is underscored by their increasing role in a wide array of applications, from enhancing natural language processing tasks to driving innovation in generative AI technologies. As the ambition for these models grows, so too does the scale of their training regimes. The escalation in training scale has made efficiency improvements not just desirable but crucial; even marginal enhancements in training efficiency can lead to substantial reductions in computational resource consumption and time, profoundly impacting the feasibility and sustainability of developing state-of-the-art LLMs.

The MoE mechanism is a sophisticated approach designed to enhance the performance and efficiency of transformer models, which are becoming increasingly pivotal in the realm of LLMs. At its core, the MoE mechanism diversifies the transformer architecture by incorporating multiple specialized network components (e.g., experts) in the feed-forward network (FFN) component. Unlike traditional transformer models that process all data through the same layers uniformly, an MoE model dynamically routes input tokens to the most relevant experts, depending on the nature of the input. This routing is typically managed by a trainable gating mechanism that decides which experts are best suited for each piece of data. This architectural innovation allows MoE models to scale significantly in terms of capacity without a proportional increase in computational costs for inference, as only a subset of the experts are activated for each input. The MoE mechanism offers a more flexible and efficient way to improve model performance beyond simply increasing the size of the network.

Within the landscape of LLM architectures, MoE models stand out for their sparsely activated architecture, which dynamically routes input tokens to a selected set of experts, rather than to all components. This design leads to sub-linear scaling of the compute budget (e.g., FLOPs) required as the model size increases, thereby significantly reducing the computational cost. Despite the inherently lower training costs of MoE, two distinct challenges nevertheless arise during MoE training. These challenges differ from the challenges encountered in training dense models.

The first challenge that arises during MoE training stems from the pronounced disparity between the characteristics of the attention mechanisms and the FFN components. For example, to facilitate sparse computation, FFN components require two additional all-to-all communications during both forward and backward computations, which typically hinder ongoing computation and consume a substantial portion of the training step time. Such a discrepancy underscores the need for tailored optimization strategies that can address the unique demands of each component effectively, thereby enhancing the overall efficiency and further reducing training costs for MoE models.

The seconds challenge that arises during MoE training is a result of the balance between computation and communication being shifted for MoE training. Parallel to the advancements in model architectures, there has been a rapid evolution in hardware capabilities, with graphics processing units (GPUs) becoming increasingly faster. Concurrently, the training precision has been reduced to facilitate more efficient and cost-effective training. These trends have led to a scenario where the raw processing time for calculations diminishes, making the relative overhead of communication between computational units a more significant bottleneck. For example, simply extending the existing intra-layer parallelism method to multi-node has been observed to cause communication overheads exceeding 50% in certain scenarios. Consequently, optimizing communication becomes paramount in maintaining and enhancing the scalability of large-scale MoE models, especially in distributed training environments where data must be synchronized across multiple devices.

Described herein is a system optimized for efficient large-scale MoE training on high-performance GPU clusters. The system described herein is a specialized LLM training system tailored for MoE models that enables the compute capabilities of high-performance GPUs to be fully unleashed. The key system principle of the system described herein is the co-design of specialized parallelism strategies and communication-computation overlap, which addresses the unique challenges posed by the attention and FFN components in MoE layers.

For the attention mechanism in large-scale MoE training, tensor parallelism is typically applied to self-attention, and sequence parallelism is typically applied to LayerNorm and Dropout operators. This deployment aims to alleviate intensive computation and minimize the activation memory footprint, respectively. However, this deployment introduces necessary all-gather and reduce-scatter communications on the critical path. As GPU compute capabilities increase and training precision decreases, the relative communication overhead becomes unsustainable. The system described herein utilizes Sequence Parallel Attention (SPA), which partitions the entire attention computation along the sequence dimension, effectively eliminating gathering and scattering operations from the critical path. The system described herein further utilizes an overlapping strategy that decomposes the projection of queries, keys, and values to hide the key-value gathering overhead in the forward pass and a hierarchical parameter synchronization approach that accounts for both intra-node and inter-node bandwidth in the backward pass.

For the FFN component, the system described herein employs expert parallelism when the model parameters exceed the memory limit of a single GPU. In this scheme, FFN components are distributed across multiple GPUs as separate experts. Due to the inherent sparsity in MoE models, all-to-all communication operations are necessary before and after expert computations and become a known primary bottleneck. To remedy this bottleneck, the system described herein utilizes Out-of-Order Expert Parallelism, which retains a portion of tokens at the expert side post-computation, thereby reducing the all-to-all communication volume by a factor of 1 over (2×top-k) while preserving computation consistency. In addition, system described herein utilizes an intra-layer pipelining approach to maximize the overlap between computation and all-to-all communication.

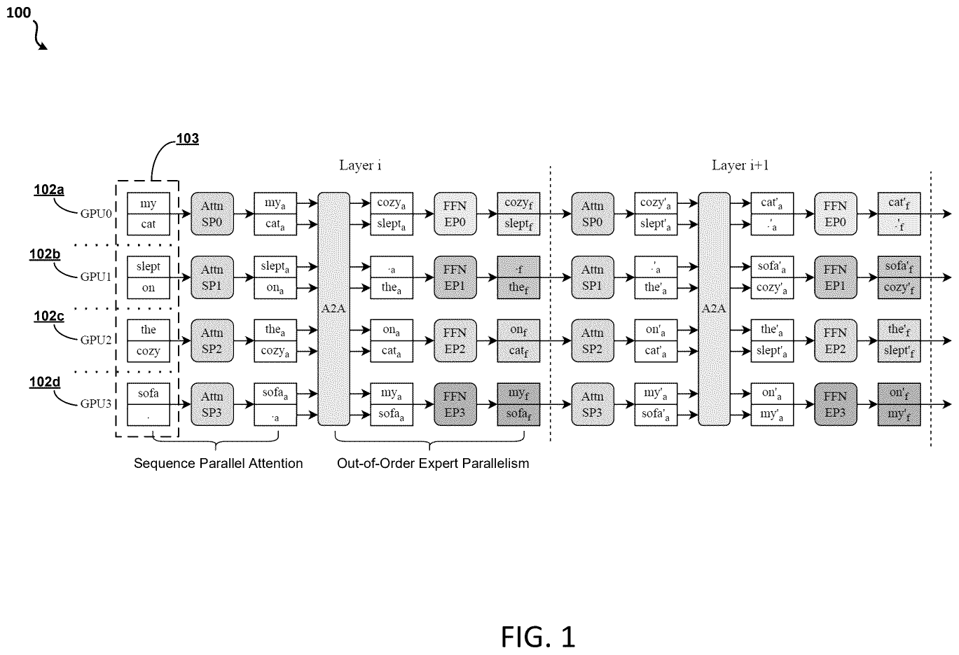

FIG. 1 shows an example system 100 for accelerating a process of training MoE models. The system 100 comprises a plurality of devices 102a-d. Each of the plurality of devices 102a-d can include a GPU and/or a network interface controller (NIC). While only four devices are shown in FIG. 1, it should be appreciated that the plurality of devices can instead include any other number of devices.

The system 100 employs SPA to address the challenges posed by the attention blocks. SPA can partition the entire attention computation along the sequence dimension. This approach can significantly reduce communication overhead by leveraging the grouped-query attention architecture. To employ SPA, each sequence (e.g., sequence 103) in training data can be partitioned into a plurality of segments. In the example of FIG. 1, the first segment comprises the tokens “my” and “cat.” The second segment comprises the tokens “slept” and “on.” The third segment comprises the tokens “the” and “cozy.” The fourth segment comprises the tokens “sofa” and “.” The plurality of segments can be input, in parallel, into the plurality of devices 102a-d. For example, the first segment can be input into the device 102a, the second segment can be input into the device 102b, the third segment can be input into the device 102c, and the fourth segment can be input into the device 102d. Attention computations of a layer (e.g., layer i) can be implemented in parallel by the plurality of devices, e.g., 102a-d.

The device 102a can implement attention computations associated with the first segment, the device 102b can implement attention computations associated with the second segment, the device 102c can implement attention computations associated with the third segment, and the device 102d can implement attention computations associated with the fourth segment. For example, the device 102a can implement attention computations associated with the first segment to generate the tokens “myₐ” and “catₐ.” The device 102b can implement attention computations associated with the second segment to generate the tokens “sleptₐ” and “onₐ.” The device 102c can implement attention computations associated with the third segment to generate the tokens “theₐ” and “cozyₐ.” The device 102d can implement attention computations associated with the fourth segment to generate the tokens “sofaₐ” and “_{.a.”}

The system 100 employs Out-of-Order Expert Parallelism to address the challenges posed by the FFN components. In the FFN block, sending all tokens back to their original device is unnecessary in expert parallelism. The Out-of-Order Expert Parallelism refrains from sending all tokens back to their original device, thereby leading to a communication cost reduction. Compared to traditional expert parallelism, Out-of-Order Expert Parallelism also introduces more balanced loads across experts.

To employ Out-of-Order Expert Parallelism, the system 100 can dispatch tokens from the attention computations of the layer (e.g., layer i) to different devices among the plurality of devices, e.g., 102a-d. The tokens from the attention computations of the layer can be dispatched to the different devices based on selected experts using all-to-all (A2A) communication. For example, the tokens “myₐ” and “catₐ” can be dispatched to the device 102d and the device 102c, respectively. The tokens “sleptₐ” and “onₐ” can be dispatched to the device 102a and the device 102c, respectively. The tokens “theₐ” and “cozyₐ” can be dispatched to the device 102b and the device 102a, respectively. The tokens “sofaₐ” and “.a” can be dispatched to the device 102d and the device 102b, respectively.

Expert computations of the layer (e.g., layer i) can be implemented by the different devices. For example, the device 102a can implement expert computation associated with the tokens “cozyₐ” and “sleptₐ” to generate the tokens “cozy_{f}” and “slept_{f}.” The device 102b can implement expert computation associated with the tokens “_{.a}” and “theₐ” to generate the tokens “_{.f}” and “the_{f}” The device 102c can implement expert computation associated with the tokens “onₐ” and “catₐ” to generate the tokens “on_{f}” and “cat_{f}.” The device 102d can implement expert computation associated with the tokens “myₐ” and “sofaₐ” to generate the tokens “my_{f}” and “sofa_{f}.”

After completing the expert computations of the layer (e.g., layer i), at least a portion of tokens from each of the different devices can be maintained on the same device for implementing attention computations of a subsequent layer (e.g., layer i+1). For example, instead of sending the tokens “cozy_{f}” and “sleptₐ” back to their original devices (e.g., device 102c and device 102b, respectively), the tokens “cozy_{f}” and “slept_{f}” can be maintained on the device 102a for implementing attention computations of the subsequent layer (e.g., layer i+1). Likewise, instead of sending the tokens “_{.f}” and “the_{f}” back to their original devices (e.g., device 102d and device 102c, respectively), the tokens “_{.f}” and “the_{f}” can be maintained on the device 102b for implementing attention computations of the subsequent layer. Instead of sending the tokens “on_{f}” and “cat_{f}” back to their original devices (e.g., device 102b and device 102a, respectively), the tokens “on_{f}” and “cat_{f}” can be maintained on the device 102c for implementing attention computations of the subsequent layer. Finally, instead of sending the tokens “my_{f}” and “sofa_{f}” back to their original devices (e.g., device 102a and device 102d, respectively), the tokens “_{.f}” and “the_{f}” can be maintained on the device 102d for implementing attention computations of the subsequent layer. By maintaining at least one portion of tokens from each of the different devices on the same device for implementing attention computations of a subsequent layer, a total communication volume can be reduced.

In embodiments, the system 100 can utilize overlapping techniques to minimize the communication overhead in SPA. To employ the overlapping techniques, the system 100 can overlap computation and communication. The projections for queries, keys, and values can be decomposed into three separate matrix multiplication operations, diverging from the traditional approach that typically employs a single matrix multiplication operation for this purpose. This strategic decomposition can facilitate the concurrent execution of the query projection computation alongside the all-gather communication process for key and value components. By facilitating this overlap, the communication overhead on the critical path can be significantly reduced, effectively approaching zero.

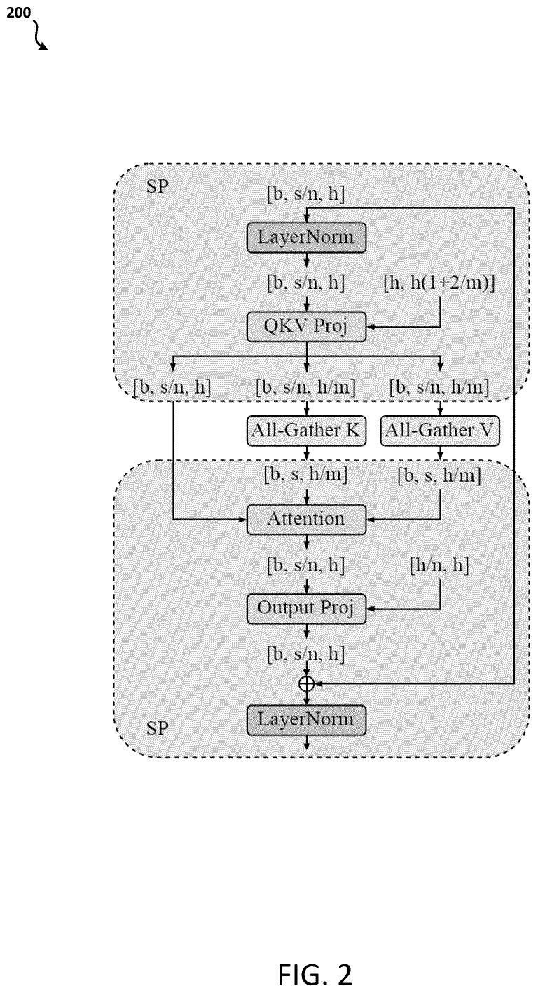

FIG. 2 shows an example system 200 for sequence parallel attention. In the training process of MoE models, tensor parallelism is typically employed to effectively parallelize the computational-intensive attention operation, while operations like LayerNorm and DropOut are parallelized along the sequence dimension to save GPU memory. However, tensor parallel attention introduces inevitable communication for gathering and scattering activations along the critical path. Scaling up the number of GPUs and leveraging lower precision computations to enhance efficiency leads to a significant reduction in the computational burden of the attention mechanism. Consequently, the relative increase in communication overhead becomes a more pressing issue. Techniques such as Multi-Query Attention (MQA) and Grouped-Query Attention (GQA), where multiple queries share identical keys and values, potentially exacerbate this issue, leading to suboptimal performance. Primarily, the heightened communication rate may negate the benefits of parallelizing the attention mechanism across GPUs. Moreover, the dominance of communication time over computation time means that the communication overhead cannot be effectively overlapped and hided.

The Sequence Parallel Attention (SPA) in accordance with the present disclosure overcomes these limitations associated with tensor parallelism. SPA can be based on the GQA architecture. As shown in the system 200, SPA efficiently partitions all the computation of the attention mechanism across the sequence dimension. Self-attention is not embarrassingly parallel along the sequence dimension due to the necessary interactions among tokens' queries, keys, and values. SPA partitions queries across devices and performs all-gather operations for keys and values before self-attention, thus maintaining computational consistency. Leveraging the GQA architecture allows for a substantial communication reduction compared to tensor parallelism, while simultaneously reducing the computation volume at a same rate.

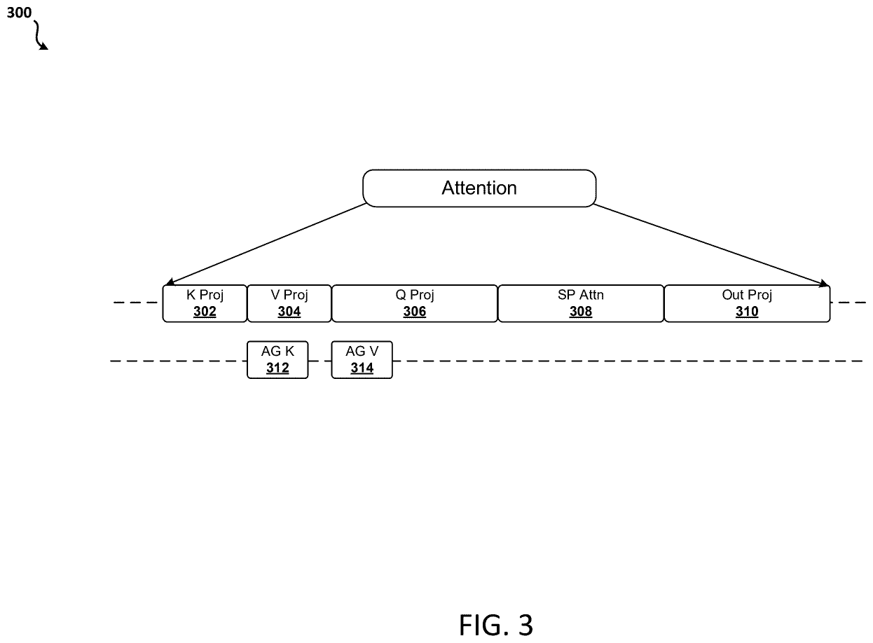

FIG. 3 shows an example attention block 300. The attention block 300 can comprise, for example, any of the attention blocks shown in FIG. 1 (e.g., Attn SP0, Attn SP1, Attn SP2, Attn SP3, etc.). Each attention block can include five operations: a key projection operation 302, a value projection operation 304, a query projection operation 306, the attention operation 308, and the output projection 310. The five operations can be performed by a GPU (e.g., one of the plurality of devices 102a-d). After the key projection operation 302 is performed, all-gather operations 312 for keys can be executed (e.g., by a NIC) while the value projection operation 304 is being performed. After the value projection operation 304 is performed, all-gather operations 314 for values can be executed (e.g., by a NIC) while the query projection operation 306 is being performed. By performing the all-gather operations 312, 314 concurrently with the value projection operation 304, a query projection operation 306, the process of training the MOE models can be accelerated.

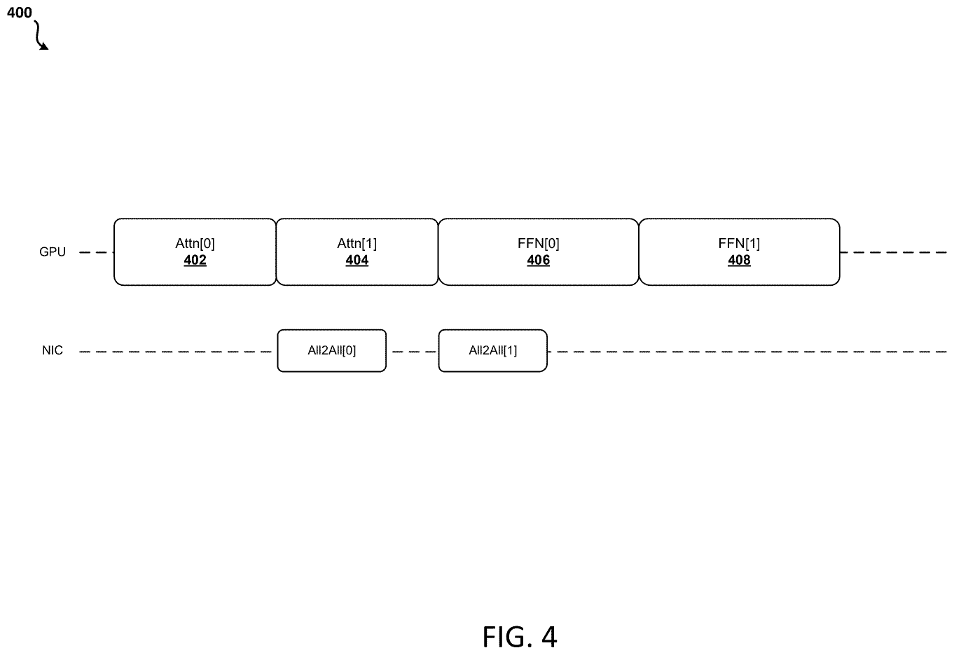

FIG. 4 shows an example overlapping communication technique 400. As described above, the system 100 can utilize overlapping techniques to minimize the communication overhead in SPA. To employ the overlapping techniques, the system 100 can overlap computation (e.g., computation by a GPU) and communication (e.g., performed by a NIC). Each attention operation can be partitioned into two chunks. In the example of FIG. 4, an attention block, such as the attention block 300, can be partitioned into two chunks: attention chunk 402 and attention chunk 404. Likewise, each FFN component can be partitioned into two chunks: FFN chunk 406, and FFN chunk 408.

After the operations associated with attention chunk 402 are performed, the operations associated with the attention chunk 404 can be performed while A2A communication is being performed between all of the attention blocks. After the operations associated with attention chunk 404 are performed, the operations associated with the FFN chunk 406 can be performed while A2A communication is being performed between all of the attention blocks. After the operations associated with the FFN chunk 406 are performed, the operations associated with the FFN chunk 408 can be performed.

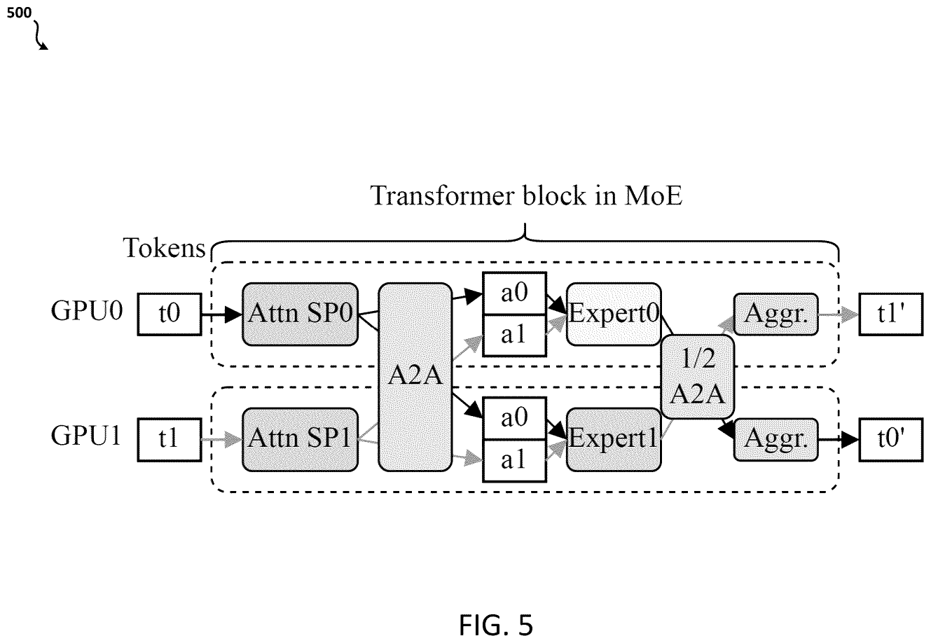

FIG. 5 shows an example system 500 for out-of-order parallelism in accordance with the present disclosure. Expert Parallelism is a common parallelization strategy used in MoE models. This strategy involves distributing experts across different devices for parallel processing. Tokens are dispatched to different devices based on the selected expert(s) using all-to-all communication. After completing the expert computations, tokens are sent back to the original device using another all-to-all communication for subsequent processing.

However, it is not necessary to revert all tokens to their original positions after the expert computations (i.e., post-computation). Consider scenarios where top-k equals 1, tokens can remain on their assigned devices for subsequent attention layer computations. While this appears to pose a challenge due to the requisite token interactions in attention computations, the application of SPA, where token computations are independently executed, mitigates this issue, allowing for uninterrupted progression.

For cases where top-k exceeds 1, the conventional gather operation at the end of expert computations introduces complexities due to the need for weighted integration of token components across devices. Nevertheless, by retaining a portion of tokens on the current device and aggregating others to this device, we effectively reduce the total all-to-all communication volume by 1 over (2×top−k). FIG. 5 shows an example of Out-of-Order Expert Parallelism 500 where top-k equals 2. The communication volume from expert computation to self-attention of the next layer is reduced by ½. Given that top-k values in MoE models predominantly range between 1 and 2, this reduction in communication volume brought by Out-of-Order Expert Parallelism is significantly impactful.

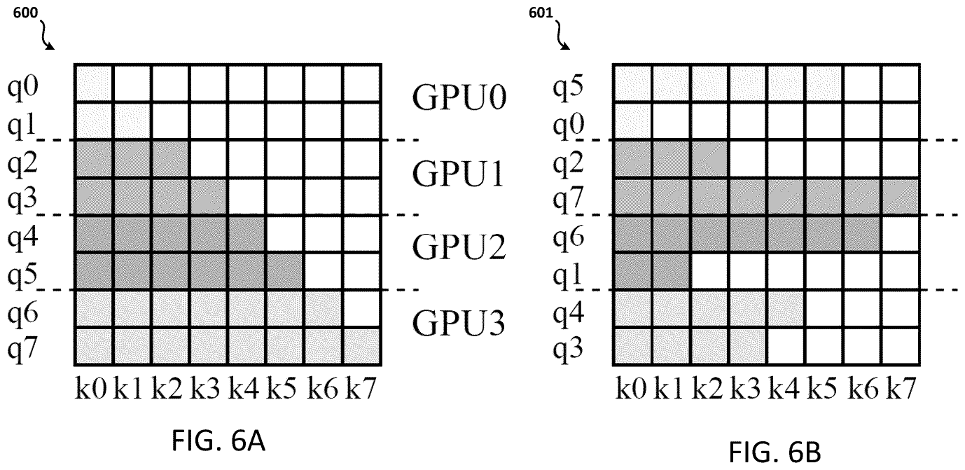

FIGS. 6A-B show an example load balancing with out-of-order parallelism in accordance with the present disclosure. Beyond reducing communication overhead, the use of Out-of-Order Expert Parallelism also contributes to load balancing in SPA. When employing SPA, computation is partitioned based on the query dimension. The causal mask can lead to an uneven distribution of computation across devices, as shown in the example distribution 600 of FIG. 6A. Subsequent ranks often handle a higher computational load as these queries compute against the majority of preceding keys and values. This imbalance in computation among ranks can lead to the straggler effect, i.e., slower devices delay the synchronization point during training.

However, by implementing Out-of-Order Expert Parallelism, where tokens are distributed across devices based on the selected expert and directly processed in the subsequent layer of attention, the causal mask is effectively shuffled along the query dimension. The causal mask leads to a more even distribution of computation across devices, as shown in the example distribution 601 of FIG. 6. This introduces a degree of load balancing, mitigating the imbalances that can be introduced by SPA.

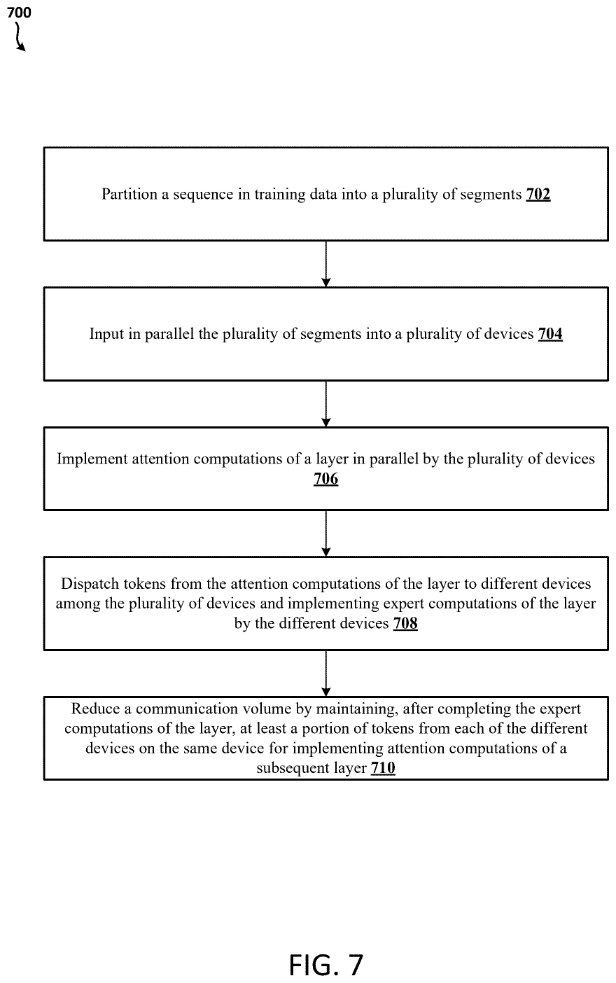

FIG. 7 illustrates an example process 700 for accelerating a process of training MoE models. Although depicted as a sequence of operations in FIG. 7, those of ordinary skill in the art will appreciate that various embodiments may add, remove, reorder, or modify the depicted operations.

The Sequence Parallel Attention (SPA) in accordance with the present disclosure can partition the entire attention computation along the sequence dimension. This approach can significantly reduce communication overhead by leveraging the grouped-query attention architecture. At 702, a sequence (e.g., sequence 103) in training data can be partitioned into a plurality of segments. For example, the sequence can be partitioned into a first segment, a second segment, a third segment, and a fourth segment. At 704, the plurality of segments can be input, in parallel, into a plurality of devices (e.g., the plurality of devices 102a-d). For example, the first segment can be input into a first device among the plurality of devices, the second segment can be input into a second device among the plurality of devices, the third segment can be input into a third device among the plurality of devices, and the fourth segment can be input into a fourth device among the plurality of devices.

At 706, attention computations of a layer (e.g., layer i) can be implemented in parallel by the plurality of devices. For example, the first device can implement attention computations associated with the first segment, the second device can implement attention computations associated with the second segment, the third device can implement attention computations associated with the third segment, and the fourth device can implement attention computations associated with the fourth segment. For example, the first device can implement attention computations associated with the first segment to generate attention token A and attention token B, the second device can implement attention computations associated with the second segment to generate attention token C and attention token D, the third device can implement attention computations associated with the third segment to generate attention token E and attention token F, and the fourth device can implement attention computations associated with the fourth segment to generate attention token G and attention token H.

At 708, tokens can be dispatched from the attention computations of the layer to different devices among the plurality of device. The tokens from the attention computations of the layer can be dispatched to the different devices based on selected experts using A2A communication. For example, the attention token A and the attention token B can be dispatched to the second device and the third device, respectively. The attention token C and the attention token D can be dispatched to the first device and the third device, respectively. The attention token E and the attention token F can be dispatched to the second device and the first device, respectively. The attention token G and the attention token H can be dispatched to the fourth device and the second device, respectively.

Expert computations of the layer can be implemented by the different devices. For example, the first device can implement expert computation associated with the attention token F and the attention token C to generate the expert token F and the expert token C, respectively. The second device can implement expert computation associated with the attention token H and the attention token E to generate the expert token H and the expert token E, respectively. The fourth device can implement expert computation associated with the tokens the attention token D and the attention token B to generate the expert token D and the expert token B, respectively. The fourth device can implement expert computation associated with the attention token A and the attention token G to generate the expert token A and the expert token G, respectively.

At 710, at least a portion of tokens from each of the different devices can be maintained on the same device for implementing attention computations of a subsequent layer (e.g., layer i+1). For example, instead of sending the expert tokens F and C back to their original devices (e.g., the third device and the second device), the expert tokens F and C can be maintained on the first device for implementing attention computations of the subsequent layer. Likewise, instead of sending the expert tokens H and E back to their original devices (e.g., the fourth device and the third device, respectively), the expert tokens H and E can be maintained on the second device for implementing attention computations of the subsequent layer. Instead of sending the expert tokens D and B back to their original devices (e.g., the second device and the first device, respectively), the expert tokens D and B can be maintained on the third device for implementing attention computations of the subsequent layer. Finally, instead of sending the expert tokens A and G back to their original devices (e.g., the first device and the fourth device, respectively), the expert tokens A and G can be maintained on the fourth device for implementing attention computations of the subsequent layer. By maintaining at least one portion of tokens from each of the different devices on the same device for implementing attention computations of a subsequent layer, a total communication volume can be reduced.

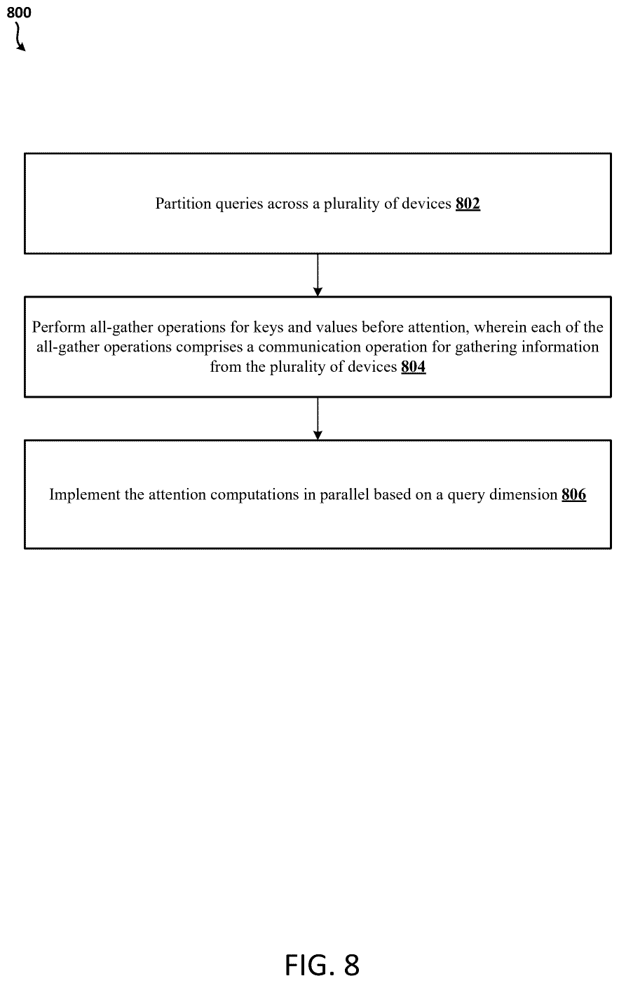

FIG. 8 illustrates an example process 800 for accelerating a process of training MoE models. Although depicted as a sequence of operations in FIG. 8, those of ordinary skill in the art will appreciate that various embodiments may add, remove, reorder, or modify the depicted operations.

SPA can efficiently partition all the computation of the attention mechanism across the sequence dimension. Self-attention is not embarrassingly parallel along the sequence dimension due to the necessary interactions among tokens' queries, keys, and values. At 802, queries can be partitioned across a plurality of devices. At 804, all-gather operations for keys and values can be performed before attention. Each of the all-gather operations can include a communication operation for gathering information from the plurality of devices. Performing all-gather operations for keys and values before self-attention can help to maintain computational consistency. At 806, the attention computations can be implemented. The attention computation can be implemented in parallel based on a query dimension.

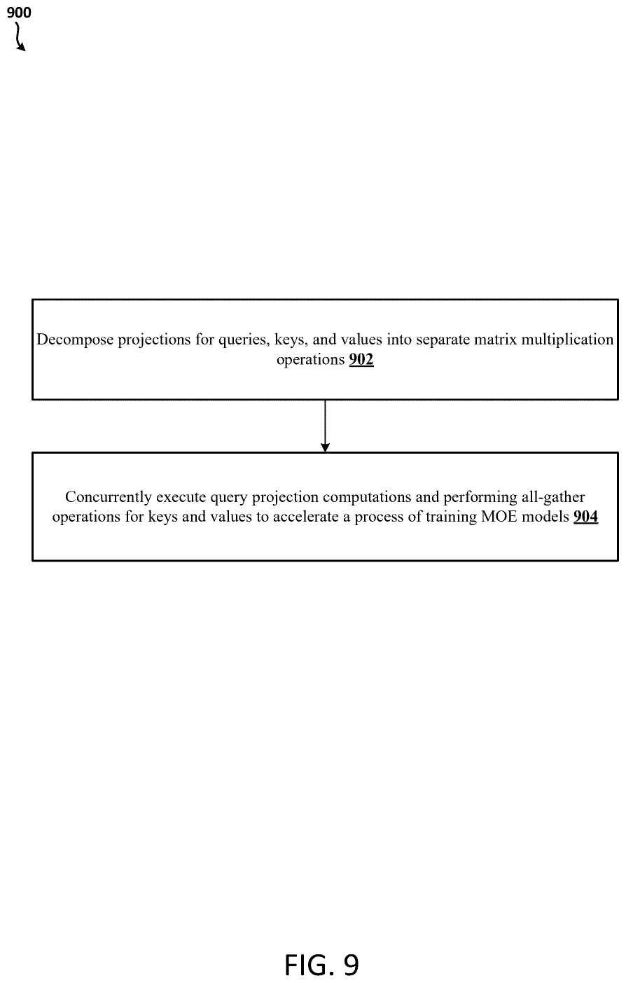

FIG. 9 illustrates an example process 900 for accelerating a process of training MoE models. Although depicted as a sequence of operations in FIG. 9, those of ordinary skill in the art will appreciate that various embodiments may add, remove, reorder, or modify the depicted operations.

A system (e.g., the system 100) can utilize overlapping techniques to minimize communication overhead in SPA. To employ the overlapping techniques, the system can overlap computation and communication. At 902, projections for queries, keys, and values can be decomposed into separate matrix multiplication operations. This diverges from the traditional approach that typically employs a single matrix multiplication operation for this purpose. This strategic decomposition can facilitate the concurrent execution of the query projection computation alongside the all-gather communication process for key and value components. At 904, query projection computations can be executed concurrently with the performance of all-gather operations for keys and values to accelerate a process of training MOE models. By facilitating this overlap, the communication overhead on the critical path can be significantly reduced, effectively approaching zero.

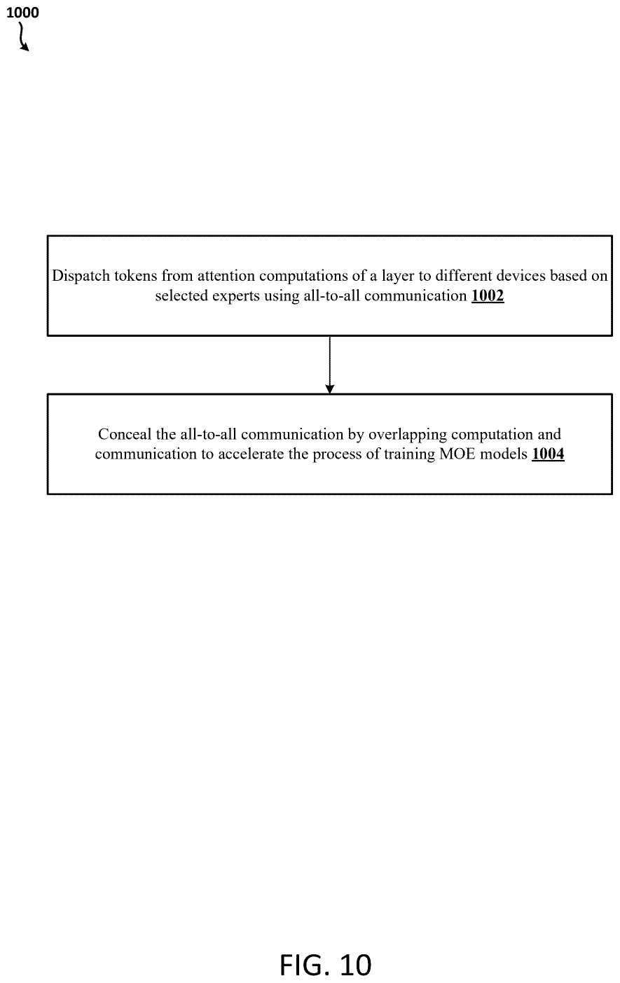

FIG. 10 illustrates an example process 1000 for accelerating a process of training MoE models. Although depicted as a sequence of operations in FIG. 10, those of ordinary skill in the art will appreciate that various embodiments may add, remove, reorder, or modify the depicted operations.

At 1002, tokens can be dispatched from the attention computations of a layer (e.g., layer i) to different devices among a plurality of devices (e.g., plurality of devices 102a-d). The tokens from the attention computations of the layer can be dispatched to the different devices based on selected experts. The tokens from the attention computations of the layer can be dispatched using all-to-all communication. At 1004, the all-to-all communication can be concealed. The all-to-all communication can be concealed by overlapping computation and communication to accelerate the process of training MOE models. Concealing the all-to-all communication can effectively conceal the communication overhead in SPA.

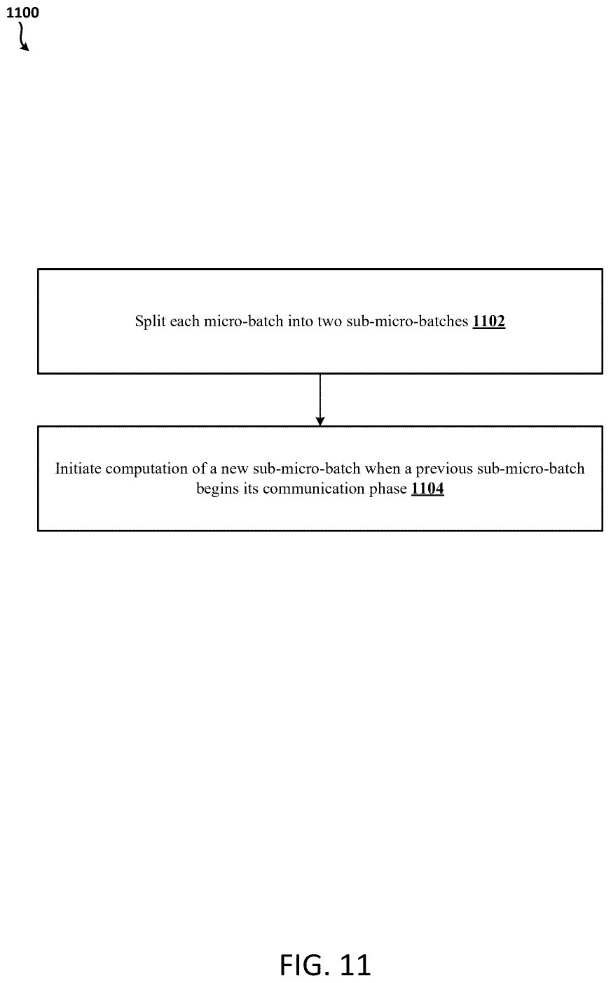

FIG. 11 illustrates an example process 1100 for accelerating a process of training MoE models. Although depicted as a sequence of operations in FIG. 11, those of ordinary skill in the art will appreciate that various embodiments may add, remove, reorder, or modify the depicted operations.

In addition to reducing the all-to-all communication volume, each micro-batch can be split into two and the computation of one micro-batch can be initiated as soon as the previous one begins its communication phase. At 1102, each micro-batch can be split into two sub-micro-batches. For example, each attention operation can be partitioned into a first attention chunk and a second attention chunk (e.g., attention chunk 402 and attention chunk 404). Likewise, each FFN component can be partitioned into a first FFN chunk and a second FFN chunk (e.g., FFN chunk 406, and FFN chunk 408).

At 1104, computation of a new sub-micro-batch can be initiated when a previous sub-micro-batch begins its communication phase. For example, after the operations associated with the first attention chunk are performed, the operations associated with the second attention chunk can be performed while A2A communication is being performed between all of the attention blocks. After the operations associated with the second attention chunk are performed, the operations associated with the first FFN chunk can be performed while A2A communication is being performed between all of the attention blocks. After the operations associated with the first FFN chunk are performed, the operations associated with the second FFN chunk can be performed.

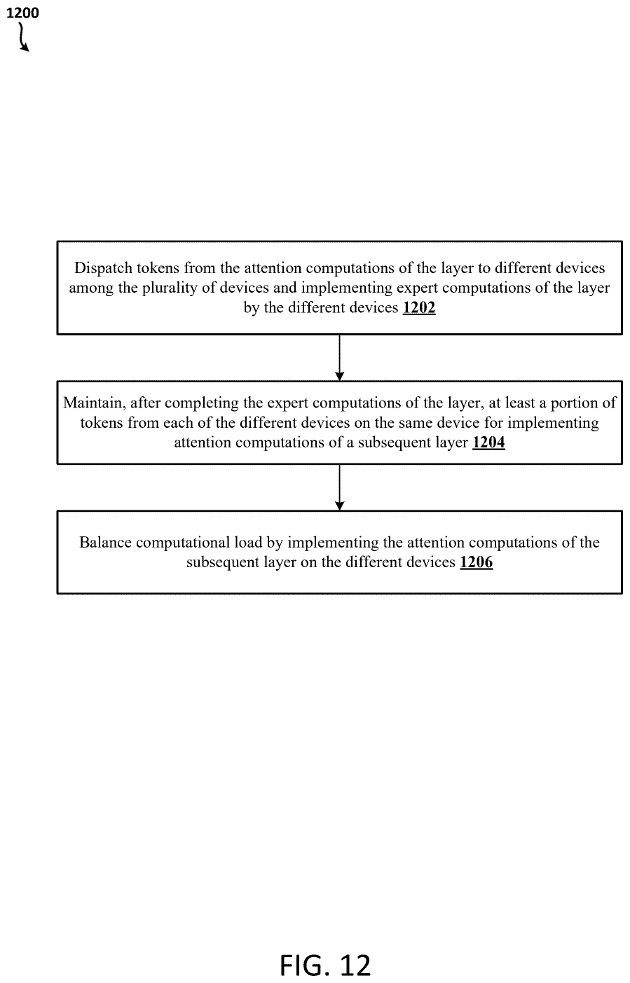

FIG. 12 illustrates an example process 1200 for accelerating a process of training MoE models. Although depicted as a sequence of operations in FIG. 12, those of ordinary skill in the art will appreciate that various embodiments may add, remove, reorder, or modify the depicted operations.

At 1202, tokens can be dispatched from the attention computations of a layer (e.g., layer i) to different devices among a plurality of devices (e.g., plurality of devices 102a-d). The tokens from the attention computations of the layer can be dispatched to the different devices based on selected experts using all-to-all communication. Expert computations of the layer can be implemented by the different devices.

At 1204, at least a portion of tokens from each of the different devices can be maintained on the same device for implementing attention computations of a subsequent layer (e.g., layer i+1). For example, instead of sending the tokens generated by the first device during expert computations back to their original device(s), the tokens generated by the first device during expert computation can be maintained on the first device for implementing attention computations of the subsequent layer. Likewise, instead of sending the tokens generated by the second device during expert computations back to their original device(s), the tokens generated by the second device during expert computation can be maintained on the second device for implementing attention computations of the subsequent layer. Instead of sending the tokens generated by the third device during expert computations back to their original device(s), the tokens generated by the third device during expert computation can be maintained on the third device for implementing attention computations of the subsequent layer. Instead of sending the tokens generated by the fourth device during expert computations back to their original device(s), the tokens generated by the fourth device during expert computation can be maintained on the fourth device for implementing attention computations of the subsequent layer. At 1206, a computational load can be balanced. The computation load can be balanced by implementing the attention computations of the subsequent layer on the different devices.

To demonstrate the effectiveness of Sequence Parallel Attention, a detailed theoretical analysis was conducted, where b represents the micro-batch size, P represents the parameter size of the attention block, s represents the sequence length, h represents the hidden dimension size, d represents the data parallel size, e represents the expert parallel size, n represents the model parallel size in the attention block, i.e., tensor or sequence parallel size, and m represents the ratio between the number of query heads and that of key-value heads.

The attention mechanism mainly involves QKV (Query, Key, Value) projection, self-attention and output projection. The total FLOPs required by the GQA mechanism are composed of the following four parts: 1) QKV projection: 2bsh2 (1+2/m)/n FLOPs; 2) QK matrix multiplication: 2bs2h/n FLOPs; 3) Attention over values: 2bs2h/n FLOPs; 4) Output projection: 2bsh2/n FLOPs. Summing the above components, the attention block necessitates a total computation of 4bsh(h+s+h/m)/n FLOPs.

For communication, when utilizing Tensor Parallelism, the communication volume is bsh(n−1)/n elements per all-gather or reduce-scatter operation. With Sequence Parallelism Attention, the communication volume decreases to bsh(n−1)/n/m elements per all-gather.

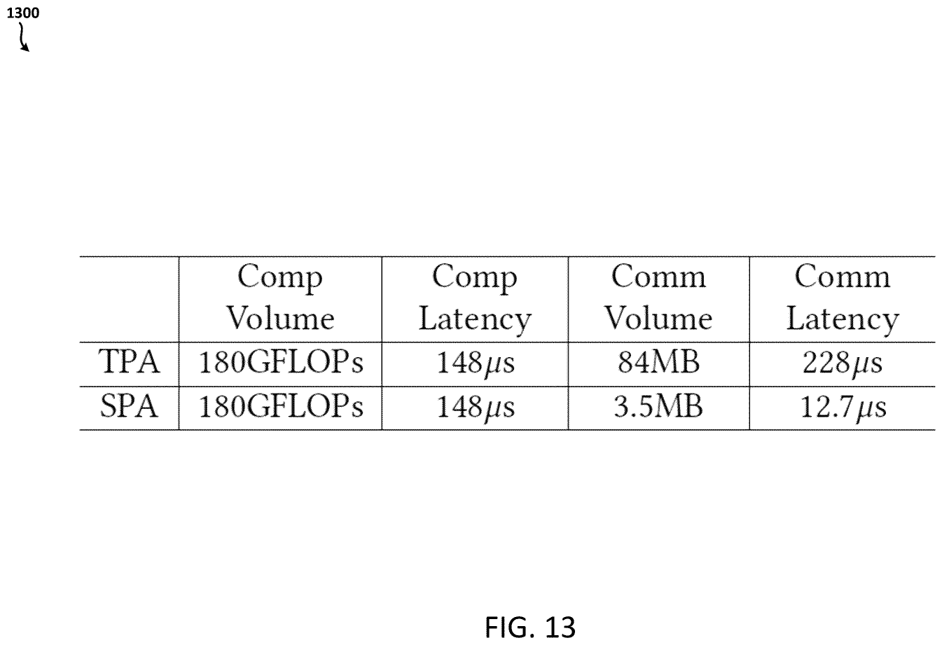

It can be assumed that the model is trained, where the peak performance is 1979 TFLOPS and the bandwidth is 450 GB/s, and all computations are executed in FP8 precision, with FP8 communication for all-gather and BF16 communication for reduce-scatter due to the latter's requirement for higher precision. Furthermore, it can be assumed that the computation and communication utilizations are both 60% under the settings (b=1, s=2, h=12288), and that the model parallelism size for self-attention n=8, and the GQA coefficient m=12 (i.e., 12 query heads share 1 key/value head). The performance is shown in the table 1300 of FIG. 13. Two observations can be made based on the table 1300. First, the communication time for Tensor Parallel Attention can significantly exceed computation time on hardware with high compute capabilities like H100 GPUs. Second, by employing Sequence Parallel Attention, the communication volume can be substantially reduced to 1/m of its original size while maintaining the same computation cost.

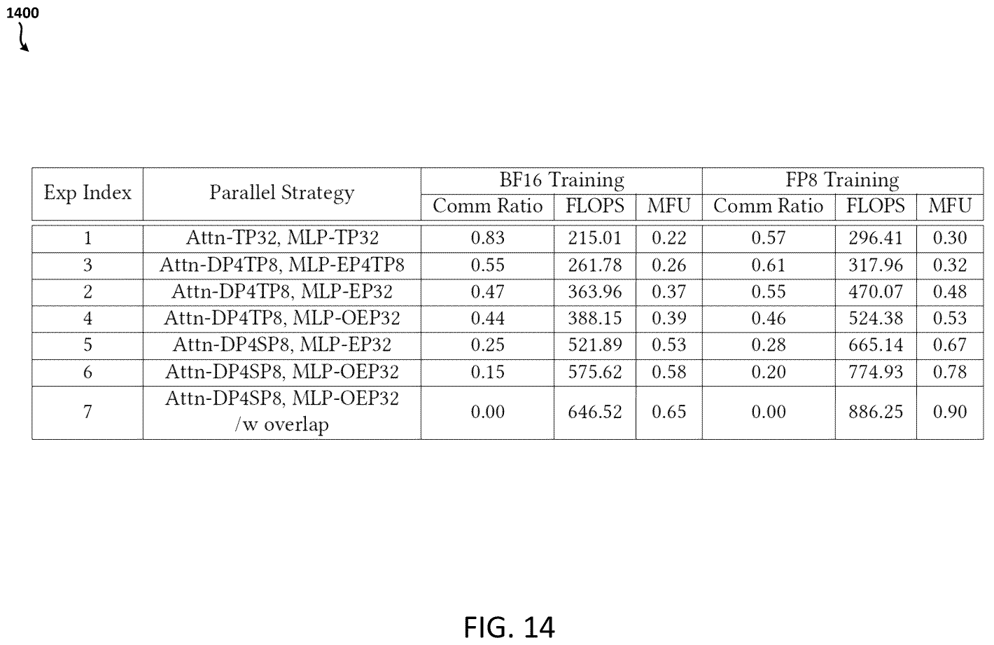

The performance of the techniques described herein were evaluated. An ablation analysis was conducted to evaluate the effectiveness of various model parallel strategies and overlapping methods. In the experiments, a setup consisting of 32 GPUs, each managing one of 32 experts, was used. The focus was primarily on analyzing the communication exposure ratio and the Model FLOPs Utilization (MFU) during the single-layer forward pass of the training procedure. Since the backward procedure is the reverse process of forward procedure, it exhibits consistent communication time, but approximately double the computation time, leading to similar conclusions. As shown in the table 1400 of FIG. 14, a naive expansion of model parallelism to a multi-node setup was initially attempted. However, as demonstrated in Experiment 1 (e.g., Exp Index 1), this approach was ineffective due to the high volume of tensor parallel communications, which constituted a significant portion of the overall training time. The attention mechanism's parallel strategy was fixed to intra-node tensor parallelism and inter-node data parallelism, and various parallel strategies were experimented with for the MLP part, such as EP32, EP4TP8, and Out-of-order EP32 (Exp Index 2, Exp Index 3, and Exp Index 4). The results confirm that the out-of-order execution strategy reduced communication overhead the most, aligning with theoretical predictions.

Further modifications were made by changing the attention component's parallel strategy from intra-node tensor parallelism to intra-node sequence parallelism attention, as shown in Exp Index 5 and Exp Index 6. This adjustment significantly reduced the communication volume in the attention mechanisms, and markedly improved the MFU. Finally, by applying the designed overlap method, the exposed communication volume was reduced to zero, achieving MFU scores of 0.65 and 0.9 under bfloat 16 and float 8 conditions, respectively, as demonstrated in Exp Index 7. This experiment also demonstrates the importance of communication optimization. When communication time is dominant, switching computation from bf16 to fp8 does not significantly enhance performance. However, once communication overhead is completely optimized, the benefits of using fp8 become significantly apparent.

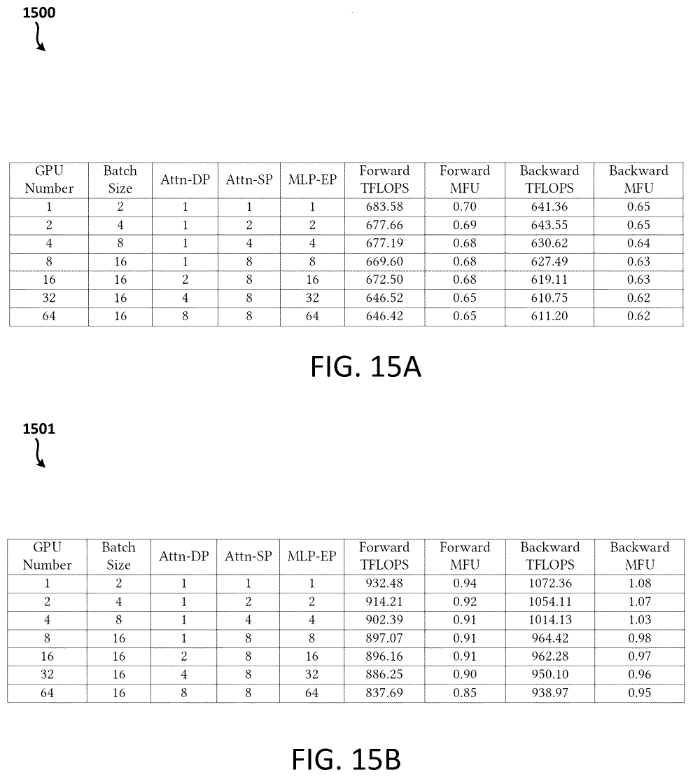

The scalability of a single layer transformer was evaluated across devices ranging from 1 to 64 GPUs, under a weak scaling setting. This setup implies that the workload per worker remains constant while the total system workload increases linearly. To achieve this, the micro-batch size was increased within each node and the number of DP units across nodes. Simultaneously, the number of experts and the expert parallelism of the MLP part were scaled in proportion to the number of GPUs. The MFU for both the forward and backward procedure are reported separately. The results in the table 1500 of FIG. 15A, which show the weak scaling performance with BF16 precision, and the table 1501 of FIG. 15B, which shows the weak scaling performance with FP8 precision, indicate that the MFU consistently maintained a very high level, with near-linear scaling observed. Even at the scale of 64 GPUs, the proportion of communication exposed during both the forward and backward phases was zero, suggesting that the communication overhead is minimal and likely cannot be further optimized. The total runtime was primarily composed of GEMM operations and other miscellaneous operations, with a slight decrease in MFU attributed to the non-linear scaling of these miscellaneous operations.

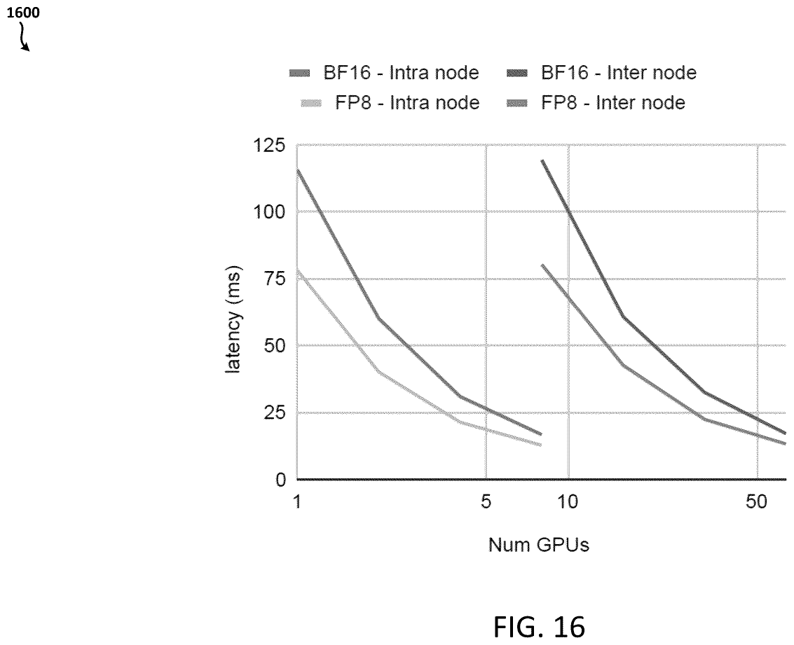

Subsequently, evaluations were conducted under a strong scaling setting. Strong scaling poses greater challenges as the total system workload remains constant while the workload assigned to each worker continually decreases. Two configurations were employed to achieve this. Within a single node, a constant micro batch size was maintained while increasing the number of sequence parallelism units. Across multiple machines, the number of data parallelism units was increased, and the micro batch size was decreased. In the strong scaling scenario, the primary concern was whether adding more workers can reduce the execution time of the task. As illustrated in the graph 1600 of FIG. 16, with an increase in the number of workers, the latency including forward and backward operations continues to decrease across different settings.

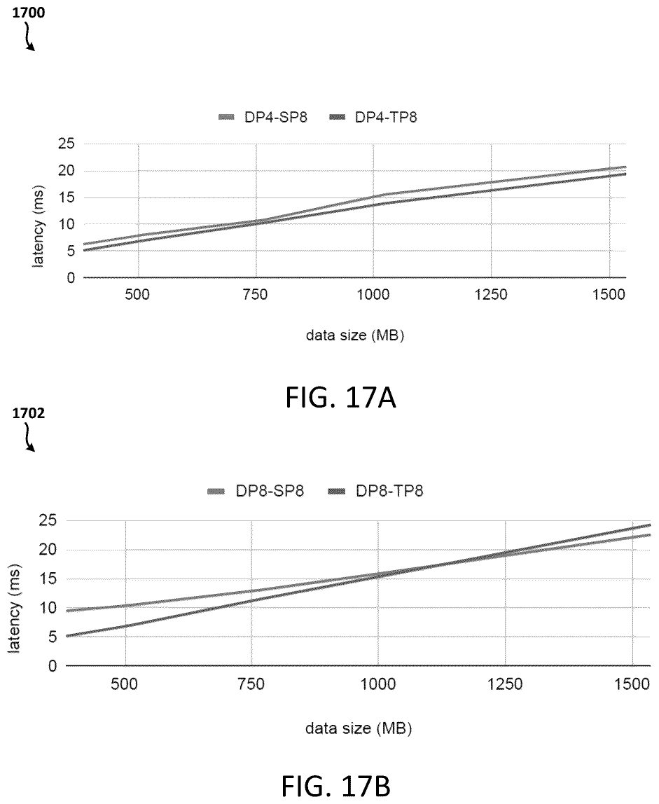

As described above, SP attention differs from TP attention by altering the parameter synchronization pattern. TP Attention requires synchronization across d DP ranks for parameters sized P/n. In contrast, SP Attention requires synchronization of full-sized P parameters across n×d ranks. Theoretically, by utilizing the hierarchical architecture of both intra-node and inter-node networks, the temporal costs associated with these synchronization processes can be approximately equivalent. Experiments were conducted to validate this theory. In the experiment, the communication latency of parameter synchronization was evaluated between TP8 and SP8 across settings of 32 and 64 GPUs. The data size was increased from 384 MB to 1536 MB. The experimental results shown in the graphs 1700 and 1701 of FIGS. 17A-B demonstrate that the latencies for TP8 and SP8 are consistently comparable, with no notable differences observed. This observation corroborates the hypothesis that the two would exhibit similar performance characteristics in term of data parallelism communication latency.

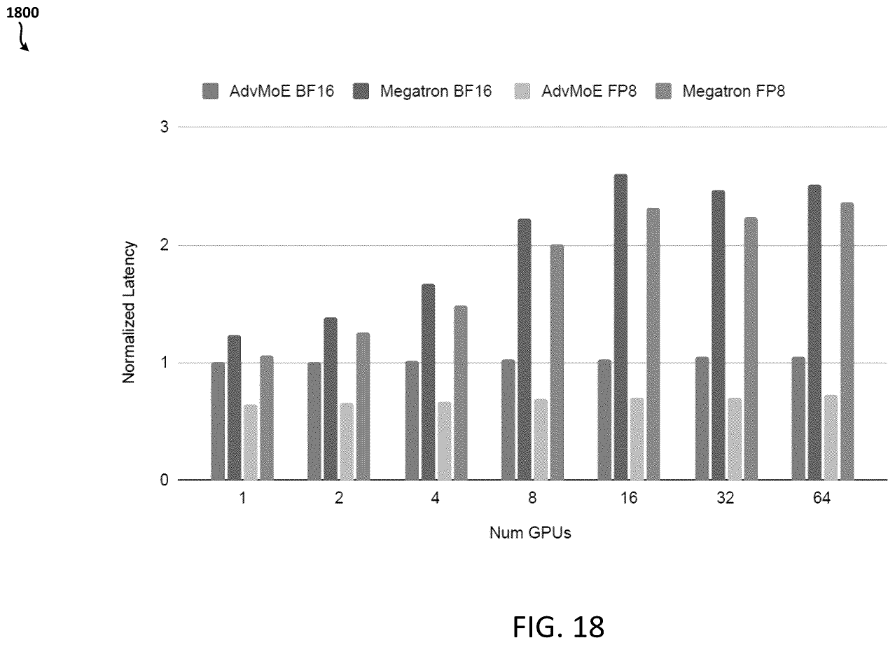

Under the weak scaling setup, the MoE training performance of the system 100 and a leading framework (e.g., Megatron) across configurations ranging from 1 to 64 GPUs, utilizing intra-layer model parallelism. The leading framework employs TP and EP to partition individual Transformer layers. As shown in the chart 1800 of FIG. 18, the latency of the system 100 (e.g., AdvMoE) remains relatively stable, while that of the leading framework progressively increases. At 64 GPUs, the system 100 can perform up to 2.5× faster than the leading framework. Several issues were identified with the implementation of the leading framework: (1) With intra-layer TP, communication involves all-gather and reduce-scatter operations, which are time-intensive on Hopper GPUs; (2) the absence of overlap in MoE training impacts performance; (3) Under the FP8 configuration, only the QKVO GEMM uses the FP8 data type, while the FFN still utilizes BF16, thus limiting the acceleration benefits of FP8.

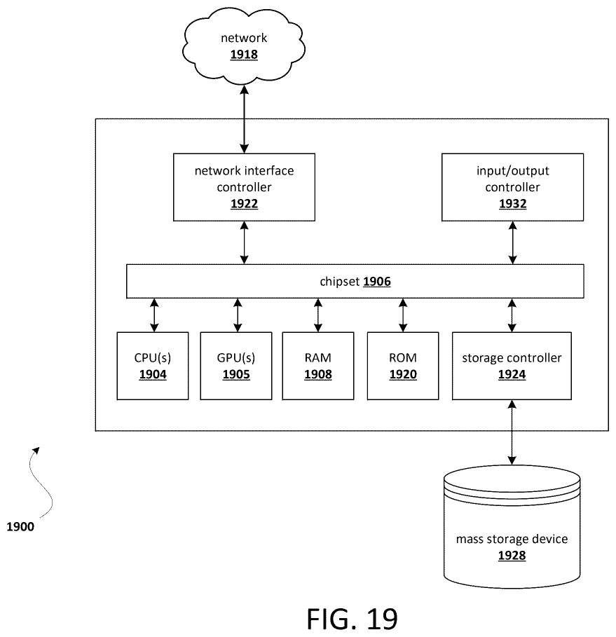

FIG. 19 illustrates a computing device that may be used in various aspects, such as the model(s), components, and/or devices depicted in FIGS. 1-5. With regard to FIGS. 1-5, any or all of the components may each be implemented by one or more instance of a computing device 1900 of FIG. 19. The computer architecture shown in FIG. 19 shows a conventional server computer, workstation, desktop computer, laptop, tablet, network appliance, PDA, e-reader, digital cellular phone, or other computing node, and may be utilized to execute any aspects of the computers described herein, such as to implement the methods described herein.

The computing device 1900 may include a baseboard, or “motherboard,” which is a printed circuit board to which a multitude of components or devices may be connected by way of a system bus or other electrical communication paths. One or more central processing units (CPUs) 1904 may operate in conjunction with a chipset 1906. The CPU(s) 1904 may be standard programmable processors that perform arithmetic and logical operations necessary for the operation of the computing device 1900.

The CPU(s) 1904 may perform the necessary operations by transitioning from one discrete physical state to the next through the manipulation of switching elements that differentiate between and change these states. Switching elements may generally include electronic circuits that maintain one of two binary states, such as flip-flops, and electronic circuits that provide an output state based on the logical combination of the states of one or more other switching elements, such as logic gates. These basic switching elements may be combined to create more complex logic circuits including registers, adders-subtractors, arithmetic logic units, floating-point units, and the like.

The CPU(s) 1904 may be augmented with or replaced by other processing units, such as GPU(s) 1905. The GPU(s) 1905 may comprise processing units specialized for but not necessarily limited to highly parallel computations, such as graphics and other visualization-related processing.

A chipset 1906 may provide an interface between the CPU(s) 1904 and the remainder of the components and devices on the baseboard. The chipset 1906 may provide an interface to a random-access memory (RAM) 1908 used as the main memory in the computing device 1900. The chipset 1906 may further provide an interface to a computer-readable storage medium, such as a read-only memory (ROM) 1920 or non-volatile RAM (NVRAM) (not shown), for storing basic routines that may help to start up the computing device 1900 and to transfer information between the various components and devices. ROM 1920 or NVRAM may also store other software components necessary for the operation of the computing device 1900 in accordance with the aspects described herein.

The computing device 1900 may operate in a networked environment using logical connections to remote computing nodes and computer systems through local area network (LAN). The chipset 1906 may include functionality for providing network connectivity through a network interface controller (NIC) 19422, such as a gigabit Ethernet adapter. A NIC 1922 may be capable of connecting the computing device 1900 to other computing nodes over a network 1916. It should be appreciated that multiple NICs 1922 may be present in the computing device 1900, connecting the computing device to other types of networks and remote computer systems.

The computing device 1900 may be connected to a mass storage device 1928 that provides non-volatile storage for the computer. The mass storage device 1928 may store system programs, application programs, other program modules, and data, which have been described in greater detail herein. The mass storage device 1928 may be connected to the computing device 1900 through a storage controller 1924 connected to the chipset 1906. The mass storage device 1928 may consist of one or more physical storage units. The mass storage device 1928 may comprise a management component 1910. A storage controller 1924 may interface with the physical storage units through a serial attached SCSI (SAS) interface, a serial advanced technology attachment (SATA) interface, a fiber channel (FC) interface, or other type of interface for physically connecting and transferring data between computers and physical storage units.

The computing device 1900 may store data on the mass storage device 1928 by transforming the physical state of the physical storage units to reflect the information being stored. The specific transformation of a physical state may depend on various factors and on different implementations of this description. Examples of such factors may include, but are not limited to, the technology used to implement the physical storage units and whether the mass storage device 1928 is characterized as primary or secondary storage and the like.

For example, the computing device 1900 may store information to the mass storage device 1928 by issuing instructions through a storage controller 1924 to alter the magnetic characteristics of a particular location within a magnetic disk drive unit, the reflective or refractive characteristics of a particular location in an optical storage unit, or the electrical characteristics of a particular capacitor, transistor, or other discrete component in a solid-state storage unit. Other transformations of physical media are possible without departing from the scope and spirit of the present description, with the foregoing examples provided only to facilitate this description. The computing device 1900 may further read information from the mass storage device 1928 by detecting the physical states or characteristics of one or more particular locations within the physical storage units.

In addition to the mass storage device 1928 described above, the computing device 1900 may have access to other computer-readable storage media to store and retrieve information, such as program modules, data structures, or other data. It should be appreciated by those skilled in the art that computer-readable storage media may be any available media that provides for the storage of non-transitory data and that may be accessed by the computing device 1900.

By way of example and not limitation, computer-readable storage media may include volatile and non-volatile, transitory computer-readable storage media and non-transitory computer-readable storage media, and removable and non-removable media implemented in any method or technology. Computer-readable storage media includes, but is not limited to, RAM, ROM, erasable programmable ROM (“EPROM”), electrically erasable programmable ROM (“EEPROM”), flash memory or other solid-state memory technology, compact disc ROM (“CD-ROM”), digital versatile disk (“DVD”), high definition DVD (“HD-DVD”), BLU-RAY, or other optical storage, magnetic cassettes, magnetic tape, magnetic disk storage, other magnetic storage devices, or any other medium that may be used to store the desired information in a non-transitory fashion.

A mass storage device, such as the mass storage device 1928 depicted in FIG. 19, may store an operating system utilized to control the operation of the computing device 1900. The operating system may comprise a version of the LINUX operating system. The operating system may comprise a version of the WINDOWS SERVER operating system from the MICROSOFT Corporation. According to further aspects, the operating system may comprise a version of the UNIX operating system. Various mobile phone operating systems, such as IOS and ANDROID, may also be utilized. It should be appreciated that other operating systems may also be utilized. The mass storage device 1928 may store other system or application programs and data utilized by the computing device 1900.

The mass storage device 1928 or other computer-readable storage media may also be encoded with computer-executable instructions, which, when loaded into the computing device 1900, transforms the computing device from a general-purpose computing system into a special-purpose computer capable of implementing the aspects described herein. These computer-executable instructions transform the computing device 1900 by specifying how the CPU(s) 1904 transition between states, as described above. The computing device 1900 may have access to computer-readable storage media storing computer-executable instructions, which, when executed by the computing device 1900, may perform the methods described herein.

A computing device, such as the computing device 1900 depicted in FIG. 19, may also include an input/output controller 1932 for receiving and processing input from a number of input devices, such as a keyboard, a mouse, a touchpad, a touch screen, an electronic stylus, or other type of input device. Similarly, an input/output controller 1932 may provide output to a display, such as a computer monitor, a flat-panel display, a digital projector, a printer, a plotter, or other type of output device. It will be appreciated that the computing device 1900 may not include all of the components shown in FIG. 19, may include other components that are not explicitly shown in FIG. 19, or may utilize an architecture completely different than that shown in FIG. 19.

As described herein, a computing device may be a physical computing device, such as the computing device 1900 of FIG. 19. A computing node may also include a virtual machine host process and one or more virtual machine instances. Computer-executable instructions may be executed by the physical hardware of a computing device indirectly through interpretation and/or execution of instructions stored and executed in the context of a virtual machine.

It is to be understood that the methods and systems are not limited to specific methods, specific components, or to particular implementations. It is also to be understood that the terminology used herein is for the purpose of describing particular embodiments only and is not intended to be limiting.

As used in the specification and the appended claims, the singular forms “a,” “an,” and “the” include plural referents unless the context clearly dictates otherwise. Ranges may be expressed herein as from “about” one particular value, and/or to “about” another particular value. When such a range is expressed, another embodiment includes from the one particular value and/or to the other particular value. Similarly, when values are expressed as approximations, by use of the antecedent “about,” it will be understood that the particular value forms another embodiment. It will be further understood that the endpoints of each of the ranges are significant both in relation to the other endpoint, and independently of the other endpoint.

“Optional” or “optionally” means that the subsequently described event or circumstance may or may not occur, and that the description includes instances where said event or circumstance occurs and instances where it does not.

Throughout the description and claims of this specification, the word “comprise” and variations of the word, such as “comprising” and “comprises,” means “including but not limited to,” and is not intended to exclude, for example, other components, integers or steps. “Exemplary” means “an example of” and is not intended to convey an indication of a preferred or ideal embodiment. “Such as” is not used in a restrictive sense, but for explanatory purposes.

Components are described that may be used to perform the described methods and systems. When combinations, subsets, interactions, groups, etc., of these components are described, it is understood that while specific references to each of the various individual and collective combinations and permutations of these may not be explicitly described, each is specifically contemplated and described herein, for all methods and systems. This applies to all aspects of this application including, but not limited to, operations in described methods. Thus, if there are a variety of additional operations that may be performed it is understood that each of these additional operations may be performed with any specific embodiment or combination of embodiments of the described methods.

The present methods and systems may be understood more readily by reference to the following detailed description of preferred embodiments and the examples included therein and to the Figures and their descriptions.

As will be appreciated by one skilled in the art, the methods and systems may take the form of an entirely hardware embodiment, an entirely software embodiment, or an embodiment combining software and hardware aspects. Furthermore, the methods and systems may take the form of a computer program product on a computer-readable storage medium having computer-readable program instructions (e.g., computer software) embodied in the storage medium. More particularly, the present methods and systems may take the form of web-implemented computer software. Any suitable computer-readable storage medium may be utilized including hard disks, CD-ROMs, optical storage devices, or magnetic storage devices.

Embodiments of the methods and systems are described below with reference to block diagrams and flowchart illustrations of methods, systems, apparatuses, and computer program products. It will be understood that each block of the block diagrams and flowchart illustrations, and combinations of blocks in the block diagrams and flowchart illustrations, respectively, may be implemented by computer program instructions. These computer program instructions may be loaded on a general-purpose computer, special-purpose computer, or other programmable data processing apparatus to produce a machine, such that the instructions which execute on the computer or other programmable data processing apparatus create a means for implementing the functions specified in the flowchart block or blocks.

These computer program instructions may also be stored in a computer-readable memory that may direct a computer or other programmable data processing apparatus to function in a particular manner, such that the instructions stored in the computer-readable memory produce an article of manufacture including computer-readable instructions for implementing the function specified in the flowchart block or blocks. The computer program instructions may also be loaded onto a computer or other programmable data processing apparatus to cause a series of operational steps to be performed on the computer or other programmable apparatus to produce a computer-implemented process such that the instructions that execute on the computer or other programmable apparatus provide steps for implementing the functions specified in the flowchart block or blocks.

The various features and processes described above may be used independently of one another or may be combined in various ways. All possible combinations and sub-combinations are intended to fall within the scope of this disclosure. In addition, certain methods or process blocks may be omitted in some implementations. The methods and processes described herein are also not limited to any particular sequence, and the blocks or states relating thereto may be performed in other sequences that are appropriate. For example, described blocks or states may be performed in an order other than that specifically described, or multiple blocks or states may be combined in a single block or state. The example blocks or states may be performed in serial, in parallel, or in some other manner. Blocks or states may be added to or removed from the described example embodiments. The example systems and components described herein may be configured differently than described. For example, elements may be added to, removed from, or rearranged compared to the described example embodiments.

It will also be appreciated that various items are illustrated as being stored in memory or on storage while being used, and that these items or portions thereof may be transferred between memory and other storage devices for purposes of memory management and data integrity. Alternatively, in other embodiments, some or all of the software modules and/or systems may execute in memory on another device and communicate with the illustrated computing systems via inter-computer communication. Furthermore, in some embodiments, some or all of the systems and/or modules may be implemented or provided in other ways, such as at least partially in firmware and/or hardware, including, but not limited to, one or more application-specific integrated circuits (“ASICs”), standard integrated circuits, controllers (e.g., by executing appropriate instructions, and including microcontrollers and/or embedded controllers), field-programmable gate arrays (“FPGAs”), complex programmable logic devices (“CPLDs”), etc. Some or all of the modules, systems, and data structures may also be stored (e.g., as software instructions or structured data) on a computer-readable medium, such as a hard disk, a memory, a network, or a portable media article to be read by an appropriate device or via an appropriate connection. The systems, modules, and data structures may also be transmitted as generated data signals (e.g., as part of a carrier wave or other analog or digital propagated signal) on a variety of computer-readable transmission media, including wireless-based and wired/cable-based media, and may take a variety of forms (e.g., as part of a single or multiplexed analog signal, or as multiple discrete digital packets or frames). Such computer program products may also take other forms in other embodiments. Accordingly, the present invention may be practiced with other computer system configurations.

While the methods and systems have been described in connection with preferred embodiments and specific examples, it is not intended that the scope be limited to the particular embodiments set forth, as the embodiments herein are intended in all respects to be illustrative rather than restrictive.

Unless otherwise expressly stated, it is in no way intended that any method set forth herein be construed as requiring that its operations be performed in a specific order. Accordingly, where a method claim does not actually recite an order to be followed by its operations or it is not otherwise specifically stated in the claims or descriptions that the operations are to be limited to a specific order, it is no way intended that an order be inferred, in any respect. This holds for any possible non-express basis for interpretation, including: matters of logic with respect to arrangement of steps or operational flow; plain meaning derived from grammatical organization or punctuation; and the number or type of embodiments described in the specification.

It will be apparent to those skilled in the art that various modifications and variations may be made without departing from the scope or spirit of the present disclosure. Other embodiments will be apparent to those skilled in the art from consideration of the specification and practices described herein. It is intended that the specification and example figures be considered as exemplary only, with a true scope and spirit being indicated by the following claims.

What is claimed is:

1. A method of accelerating a process of training mixture-of-experts (MOE) models, comprising:
partitioning a sequence in training data into a plurality of segments;
inputting in parallel the plurality of segments into a plurality of devices;
implementing attention computations of a layer in parallel by the plurality of devices;
dispatching tokens from the attention computations of the layer to different devices among the plurality of devices and implementing expert computations of the layer by the different devices; and
reducing a communication volume by maintaining, after completing the expert computations of the layer, at least a portion of tokens from each of the different devices on the same device for implementing attention computations of a subsequent layer.

2. The method of claim 1, wherein the implementing attention computations of a layer in parallel by the plurality of devices comprises:
partitioning queries across the plurality of devices; and
implementing the attention computations in parallel based on a query dimension.

3. The method of claim 2, further comprising:
performing all-gather operations for keys and values before self-attention, wherein each of the all-gather operations comprises a communication operation for gathering information from the plurality of devices.

4. The method of claim 1, wherein the implementing attention computations of a layer in parallel by the plurality of devices comprises:
decomposing projections for queries, keys, and values into separate matrix multiplication operations.

5. The method of claim 4, further comprising:
concurrently executing query projection computations and performing all-gather operations for keys and values to accelerate the process of training the MOE models.

6. The method of claim 1, further comprising:
dispatching the tokens from the attention computations of the layer to the different devices based on selected experts using all-to-all communication; and
concealing the all-to-all communication by overlapping computation and communication to accelerate the process of training the MOE models.

7. The method of claim 6, further comprising:
splitting each micro-batch into two sub-micro-batches; and
initiating computation of a new sub-micro-batch when a previous sub-micro-batch begins its communication phase.

8. The method of claim 1, further comprising:
balancing computational load by distributing the tokens across the different devices for the expert computations and then directly proceeding with the attention computations in the subsequent layer.

9. A system of accelerating a process of training mixture-of-experts (MOE) models, comprising:
at least one processor; and
at least one memory communicatively coupled to the at least one processor and comprising computer-readable instructions that upon execution by the at least one processor cause the at least one processor to perform operations comprising:
partitioning a sequence in training data into a plurality of segments;
inputting in parallel the plurality of segments into a plurality of devices;
implementing attention computations of a layer in parallel by the plurality of devices;
dispatching tokens from the attention computations of the layer to different devices among the plurality of devices and implementing expert computations of the layer by the different devices; and
reducing a communication volume by maintaining, after completing the expert computations of the layer, at least a portion of tokens from each of the different devices on the same device for implementing attention computations of a subsequent layer.

10. The system of claim 9, wherein the implementing attention computations of a layer in parallel by the plurality of devices comprises:
partitioning queries across the plurality of devices; and
implementing the attention computations in parallel based on a query dimension.

11. The system of claim 10, the operations further comprising:
performing all-gather operations for keys and values before self-attention, wherein each of the all-gather operations comprises a communication operation for gathering information from the plurality of devices.

12. The system of claim 9, wherein the implementing attention computations of a layer in parallel by the plurality of devices comprises:
decomposing projections for queries, keys, and values into separate matrix multiplication operations; and
concurrently executing query projection computations and performing all-gather operations for keys and values to accelerate the process of training the MOE models.

13. The system of claim 9, the operations further comprising:
dispatching the tokens from the attention computations of the layer to the different devices based on selected experts using all-to-all communication; and
concealing the all-to-all communication by overlapping computation and communication to accelerate the process of training the MOE models.

14. The system of claim 9, the operations further comprising:
balancing computational load by distributing the tokens across the different devices for the expert computations and then directly proceeding with the attention computations in the subsequent layer.

15. A non-transitory computer-readable storage medium, storing computer-readable instructions that upon execution by a processor cause the processor to implement operations comprising:
partitioning a sequence in training data into a plurality of segments;
inputting in parallel the plurality of segments into a plurality of devices;
implementing attention computations of a layer in parallel by the plurality of devices;
dispatching tokens from the attention computations of the layer to different devices among the plurality of devices and implementing expert computations of the layer by the different devices; and
reducing a communication volume by maintaining, after completing the expert computations of the layer, at least a portion of tokens from each of the different devices on the same device for implementing attention computations of a subsequent layer.

16. The non-transitory computer-readable storage medium of claim 15, wherein the implementing attention computations of a layer in parallel by the plurality of devices comprises:
partitioning queries across the plurality of devices; and
implementing the attention computations in parallel based on a query dimension.

17. The non-transitory computer-readable storage medium of claim 16, the operations further comprising:
performing all-gather operations for keys and values before self-attention, wherein each of the all-gather operations comprises a communication operation for gathering information from the plurality of devices.

18. The non-transitory computer-readable storage medium of claim 15, wherein the implementing attention computations of a layer in parallel by the plurality of devices comprises:
decomposing projections for queries, keys, and values into separate matrix multiplication operations; and
concurrently executing query projection computations and performing all-gather operations for keys and values to accelerate the process of training the MOE models.

19. The non-transitory computer-readable storage medium of claim 15, the operations further comprising:
dispatching the tokens from the attention computations of the layer to the different devices based on selected experts using all-to-all communication; and
concealing the all-to-all communication by overlapping computation and communication to accelerate the process of training the MOE models.

20. The non-transitory computer-readable storage medium of claim 15, the operations further comprising:
balancing computational load by distributing the tokens across the different devices for the expert computations and then directly proceeding with the attention computations in the subsequent layer.
